(19) United States
(12) Patent Application Publication
(10) Pub. No.: US 2017/0079865 A1
(43) Pub. Date: Mar. 23, 2017

(54) DEVICE FOR MASSAGE

(71) Applicant: Jui-Hung Kao, Taipei (TW)

(72) Inventor: Jui-Hung Kao, Taipei (TW)

(21) Appl. No.: 15/063,517

(22) Filed: Mar. 8, 2016

(30) Foreign Application Priority Data
Sep. 23, 2015 (CN) 201510611608.2

(51) Int. Cl. A61H 1/00

(52) U.S. Cl. CPC A61H 1/008; A61H 2201/0157; A61H 2201/123; A61H 2201/5025

(57) ABSTRACT

An improved massager that includes a chassis with a housing space, whereas the housing space is connected to the outside through two openings. Two impact power units is configured inside the housing space, each provide a partial portion to pass through the two openings to extend outside of the chassis, and each connects to a massage head. The improved massager also includes a control unit includes a main circuit board, an operational switch with at least one level of operational state, and a control circuit board to link to the impact power units. In the control circuit board, there are multiple adjustment units. Each adjustment unit is linked with the adjustment knob outside of the chassis. The side of the chassis extends a grip portion configured with a control operational switch that has at least one state of operation. By adjusting each adjustment knobs, the adjustment units can provide different level of control adjustment so that the circuit board can control the two impact power units to provide different impacts from linear regular motion features with different forces and frequencies.

### CROSS REFERENCE TO RELATED APPLICATIONS

This non-provisional application claims priority under 35 U.S.C. §119(a) on Patent Application Serial No. 201510611608.2 filed in China on Sep. 23, 2015, the entire contents of which are hereby incorporated by reference.

### BACKGROUND OF THE INVENTION

Field of Invention

This invention relates generally to an improved massager, and more particularly to a massager that can provide a regular linear-motion impact with different forces and frequencies.

Related Art

A small massager commonly achieves a vibrating massage effect through using a motor with an eccentric load to generate a high speed (over 60 times per second) rotation motion or through applying a high speed (over 60 times per second) electromagnetic vibration to generate a contraction-extension motion. Such motions, however, may only deliver a relaxing effect to the skin surface or shallow muscle group of the pain spot. To eliminate joint pain and activate, the massager must provide a low speed (2-12 times per second) regular linear-motion impact toward the deep tissue, spine, joints, or soft tissue.

In the current market, the small, handheld, massagers have structures as disclosed in the Chinese patent application number 201320389376.7, entitled “A massager with improved structure.” It discloses an outer chassis with an upper sleeve. Inside the upper sleeve, it has an electromagnetic element formed by a wounded coil around a central conduit. A driving unit group has a driving pillar that extends into the central conduit and driven by the electromagnetic effect. One side of the driving pillar is coupled to a fit member. The other side of the driving pillar covers a spring through an upper link, and then fixed on to the terminal end of the upper link through a stopper. A transmission unit includes lower sleeve connected to the upper sleeve. The lower sleeve has a center hole to contain the fit member, and a driving pillar to extend inside the center hole to couple with the fit member. The mid-section of the driving pillar has an axially extending guide groove. The peripheral side of the lower sleeve has a transverse projection extending into the inside of the guided pin of the center hole to guide the lateral motion of the driving pillar. A fixture is coupled to the driving pillar at a terminal end that is away from the fit member, and it is equipped with a combination end to combine with the massage head. As such, the stretching motion cycle of the massage motion can be achieved from the electromagnetic element through the driving unit, transmission unit and fixture to drive the massage head.

Similar structure like the aforementioned cannot be configured to apply different forces or frequencies of regular linear-motion impacts at the same time. Therefore, it cannot satisfy the need of applying a low-speed, regular linear-motion impact toward meridian point, local deep muscle groups, spine, joint, or soft tissue.

In light of the drawbacks of the current small, handheld massagers, embodiments of the present invention provide an improved massager.

### SUMMARY OF THE INVENTION

The present invention provides an improved massager. It combines two sets of impact power units inside a chassis and applies different control mechanisms toward them. This allows them to apply different regular linear-motion impacts with different forces and frequencies to quickly provide a relaxing effect for the discomfort caused by spine or joint adhesions, rotation, or dislocation and easy to activate these tissue.

An object of the present invention can be reached by an improved massager that comprises a chassis with a housing space wherein the chassis reaches out through two openings at a side of the chassis; two impact power units configured inside the housing space and partially passing through the two openings to respectively connect to two massage heads; and a control unit comprising a main circuit board, an operational switch with at least one mode of operation, a control circuit board, and a plurality of adjustment knobs configured outside of the chassis to be linked with a plurality of adjustment units on the control circuit board, wherein the main circuit board is connected to the control circuit board and the two impact power units to drive the plurality of adjustment units through the operational switch to provide different configurations for the two impact power units so that the two massage heads can provide regular linear-motion impacts with different forces and frequencies.

In addition, the chassis laterally may extend a grip portion that has the operational switch to control the two impact power units.

In addition, the chassis may comprise two corresponding side cases and a back cover that combines with the two corresponding side cases.

In addition, the two impact power units may be similarly structured to comprise an electromagnetic element, a driving unit group, a transmission unit, and a fixture, wherein the electromagnetic element comprise a wounded coil with a through hole, wherein the driving unit group comprises a driving pillar capable of reaching through the through hole and connects to a link that also connects to a fit member, wherein the transmission unit partially extends outside of a lower sleeve of the chassis, and wherein the lower sleeve comprises a center hole associated with the fit member and a driving pillar that at one end reaches inside the center hole to be placed against the fit member and at another end reaches the fixture.

In addition, the electromagnetic element may be placed inside an upper sleeve that combines with an end plug with a hole for the link to pass through, wherein the link is surrounded by a spring to be placed against the driving pillar and the end plug, and wherein the lower sleeve is surrounded by a linking cylinder to be coupled to an end of the end plug that is away from the upper sleeve.

In addition, the linking cylinder may be placed inside and against the opening of the chassis, and wherein the lower sleeve extends outward through the opening.

In addition, a middle section of the lower sleeve may have a ring flange to stop an outer flange of the driving pillar to prevent the driving pillar from sliding outward.

In addition, the grip portion of the chassis may be hollow and contains the main circuit board.

### BRIEF DESCRIPTION OF THE DRAWINGS

The invention will become more fully understood from the detailed description and accompanying drawings, which are given for illustration only, and thus are not limitative of the present invention, and wherein:

FIG. 1 provides a structure diagram according to an embodiment of the present invention.

FIG. 2 provides a rear view combination diagram according to an embodiment of the present invention.

FIG. 3 provides a front view combination diagram according to an embodiment of the present invention.

FIG. 4 provides a structure diagram of a impact power unit according to an embodiment of the present invention.

FIG. 5 provides a sectional view of the entire set according to an embodiment of the present invention.

FIG. 6 provides an illustrative view of the operation according to an embodiment of the present invention.

FIG. 7 provides an illustrative view of the right-rotation symptom of the lower lumbar according to an embodiment of the present invention.

FIG. 8 provides an illustrative view of the left-rotation symptom of the spine joint according to an embodiment of the present invention.

### DETAILED DESCRIPTION OF THE INVENTION

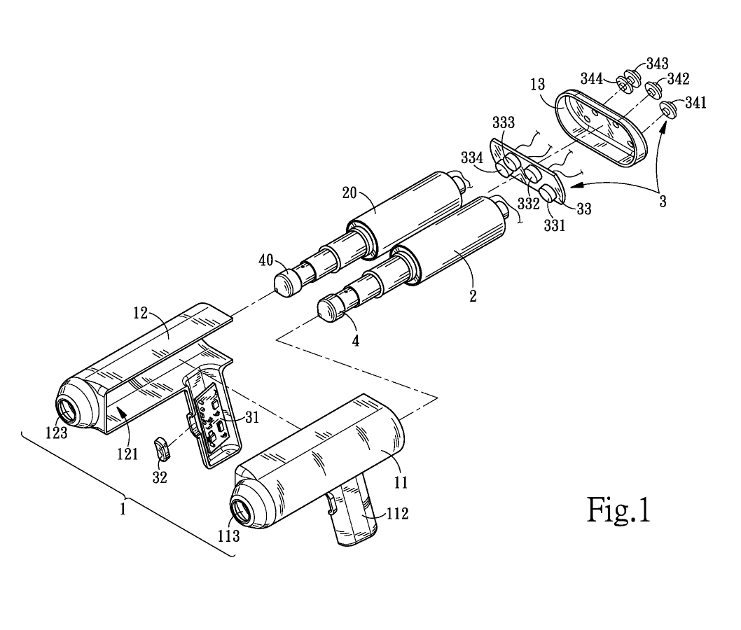

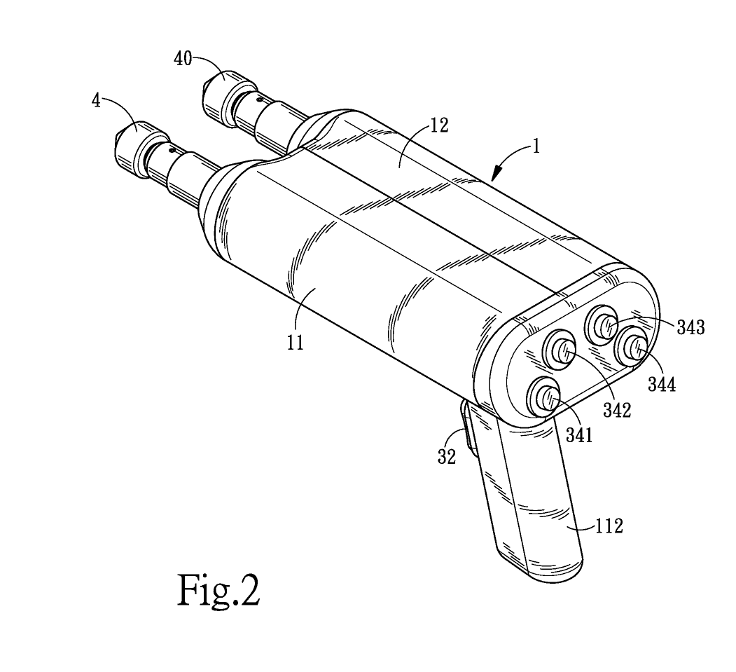

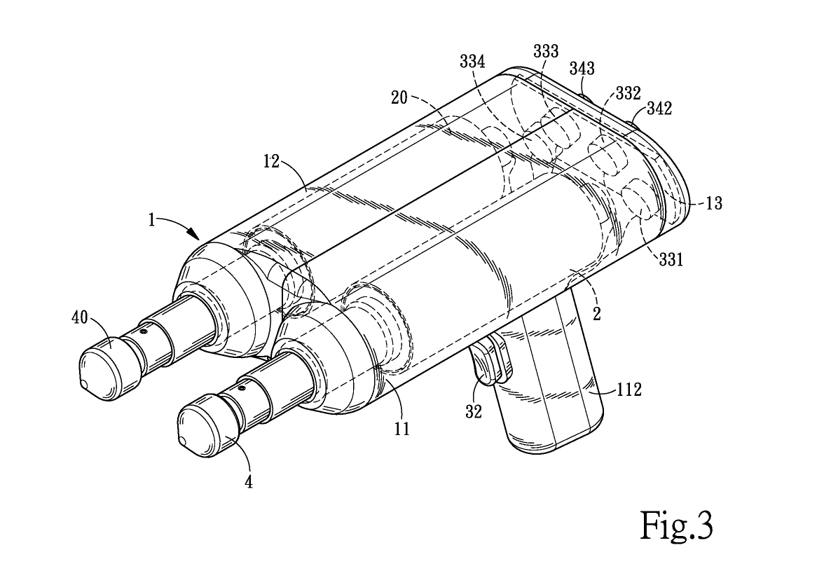

Referring to FIGS. 1-3, embodiments of the present invention include a chassis 1, two impact power units 2 and 20, a control module 3, and two massage heads 4 and 40. The chassis 1 has two side cases 11 and 12 to combine with each other and a back cover 13 that combines with the side cases 11 and 12. Inside the side cases 11 and 12, there is the housing space 121. One end of the housing space 121 reaches outside through the openings 113 and 123. It also forms a hollow grip portion 112 on the side of the chassis 1.

The two impact power units 2 and 20 have the same structure, and are placed in the housing space 121 in parallel. The two impact power units 2 and 20 have partial portions to pass through the two openings 113 and 112 to extend outside of the chassis 1.

The control unit 3 includes a main circuit board 31, an operational switch 32 with at least one mode of operation (preferably three modes of operation), and a control circuit board 33. The main circuit board 31 can be contained in the grip portion 112 (or housing space 121) of the chassis 1. The three-mode operational switch 32 can be configured to the outer portion of the grip portion 112 so it can more easily control the two impact power units 2 and 20. The control circuit board 33 has multiple adjustment units 331, 332, 333 and 334 to be respectively linked to the adjustment knobs 341, 342, 343, and 344. The main circuit board 31 is electrically connected to the control circuit board 33 and impact power units 2 and 20.

In real application, the adjustment knobs 341, 342, 343 and 344 can respectively activate the adjustment units 331, 332, 333 and 334 to apply different electric connection for the adjustment. For example, the adjustment knobs 341 and 342 can respectively activate the adjustment units 331 and 332 to configure the impact force and frequency of the impact power unit 2. The adjustment knobs 343 and 344 can respectively activate the adjustment units 333 and 334 to configure the impact force and frequency of the impact power unit 20. This will allow the main circuit board 3 to control each of the two impact power units 2 and 20 through the control circuit board 33 to offer them different forces and frequencies of regular linear-motion impacts. The three-mode operational switch 32 can control the main circuit board 31 and control circuit board 33. For example, an upper pressing motion can be linked with the impact power unit 2, and a downward pressing motion can be linked with the impact power units 2 and 20, or the default power source (not shown).

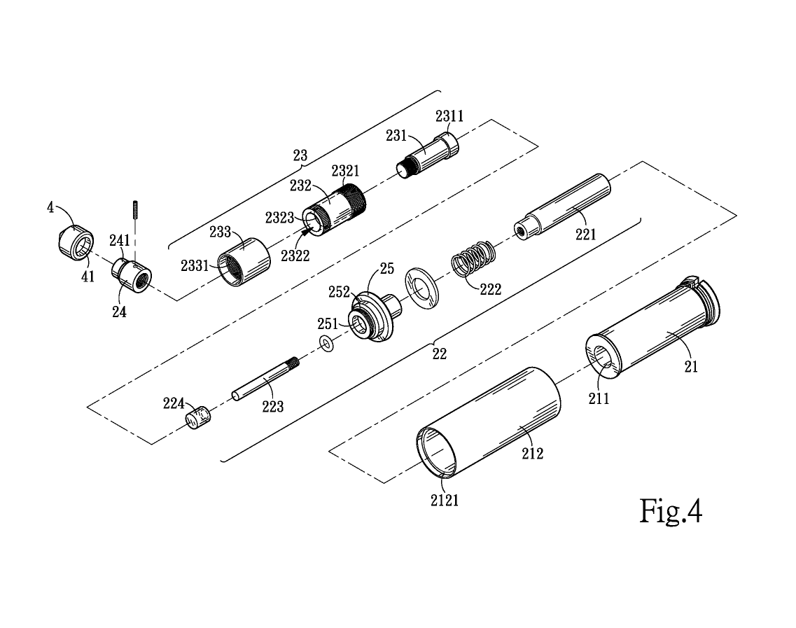

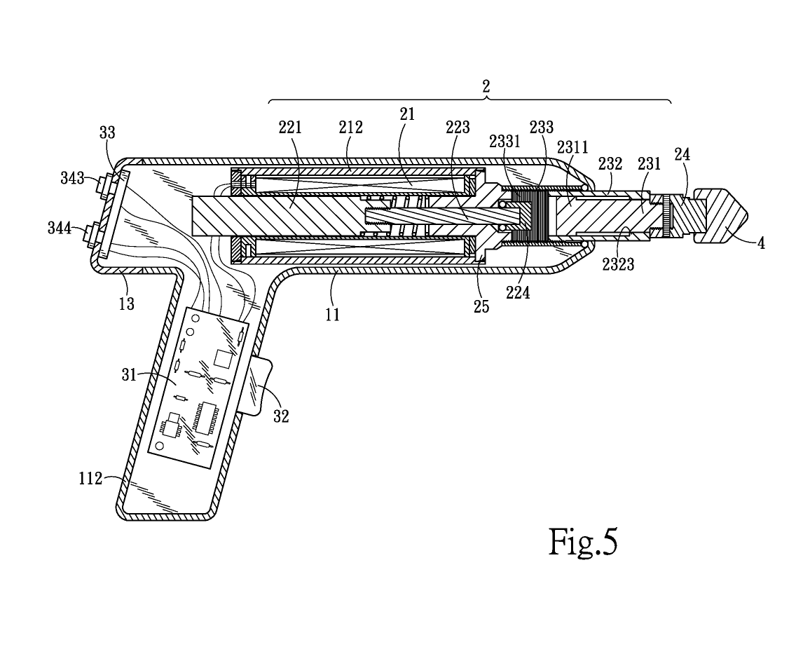

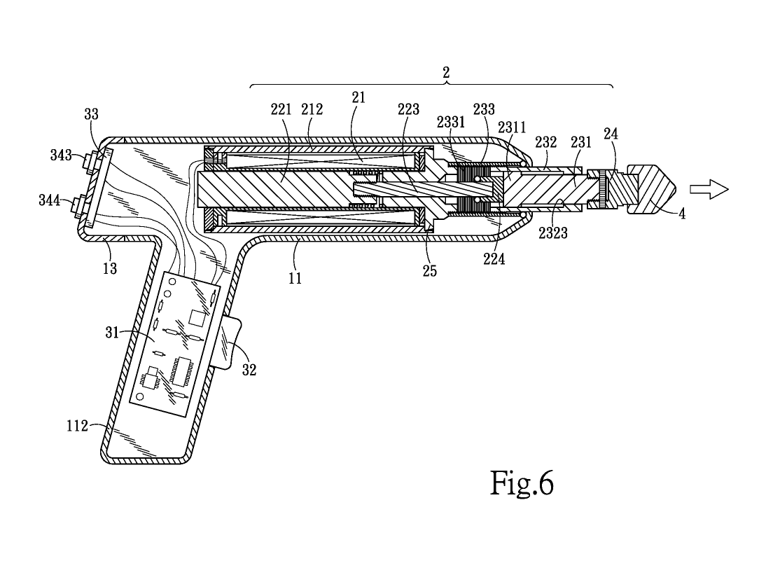

Referring to FIGS. 4-6, in some embodiments of the present invention, the impact power unit 2 can include an electromagnetic element 21, a driving unit group 22, a transmission unit 23 and a fixture 24. The electromagnetic element 21 may be a wire-wound coil with a through hole 211 at its center. The periphery of the electromagnetic element 21 may optionally be covered by an upper sleeve 212. Inside one end of the upper sleeve 212, it may have a stopper portion 2121 to stop the end plug 25 which may have a center hole 251 that has an external thread 252 at its outer peripheral section.

The driving unit group 22 may include a driving pillar 221, a spring 222, a link 223, and a fit member 224. One end of the driving pillar 221 may slide in through hole 211 of the electromagnetic element 21. The link 223 is passed through the hole 251 of the end plug 25, and connected to the driving pillar 221. The fit member 224 is coupled to the other end of the link 223. A spring 222 may cover the the link 223 such that its two terminal ends will be against the driving pillar 221 and the end plug 25. This will allow the driving pillar 221 to have an elastic force to return to its original position by the force provided by the spring 222.

The transmission unit 23 may include a driving pillar 231, a lower sleeve 232 and a linking cylinder 233. One end of the linking cylinder 233 may have a screw 2331. The lower sleeve 232 has an external thread 2321 to allow the lower sleeve 232 to pass through the linking cylinder 233, and to connect to the screw 2331 through the external thread 2321. This allows the other end of the lower sleeve 232 to extend outside through the linking cylinder 233. The screw 2331 may connect to the external thread 252 of the end plug 25 to allow the linking cylinder 233 to be coupled to the end plug 25. The lower sleeve 232 has a center hole 2322 that has a ring flange 2323 at its middle section. The driving pillar 231 passes through the center hole 2322 of the lower sleeve 232 and has an outer flange 2311 at one of its terminal ends. The outer flange 2311 may be stopped by the ring flange 2323 to stop the driving pillar 231 to slid out from the lower sleeve 232.

The fixture 24 is combined with the terminal end of the driving pillar 231 that is away from the outer flange 2311. In some embodiments of the present invention, the massage head 4 has a recessed hole 41. The fixture 24 has a corresponding combination end 241 to fit to the recessed hole 41. This allows the fixture 24 to combine with different massage head 4 based on user requirement.

During the assembly process, one end of the linking cylinder 233 can be placed against the inner peripheral of the opening 113 to allow the lower sleeve 232 to pass through the opening 113 to extend outward. The driving pillar 231 may pass through the center hole 2322 to reach out of the chassis 1 and to combine with the massage head 4 through the fixture 24. In its operation, the electromagnetic element 21, when the electricity is on, can produce electromagnetic force to drive the driving pillar 221 to oscillate back and forth with the spring 222 in the through hole 211. The driving pillar 221 may push the fit member 224 through the link 223. The fit member 224 may impact the driving pillar 231, and drives the massage head 4 through the driving pillar 231 and the fixture 24. This will allow the massager to provide a vibrating impact effect on a human's body.

The impact power unit 20 has the same structure as the impact power unit 2, and will not be further explained.

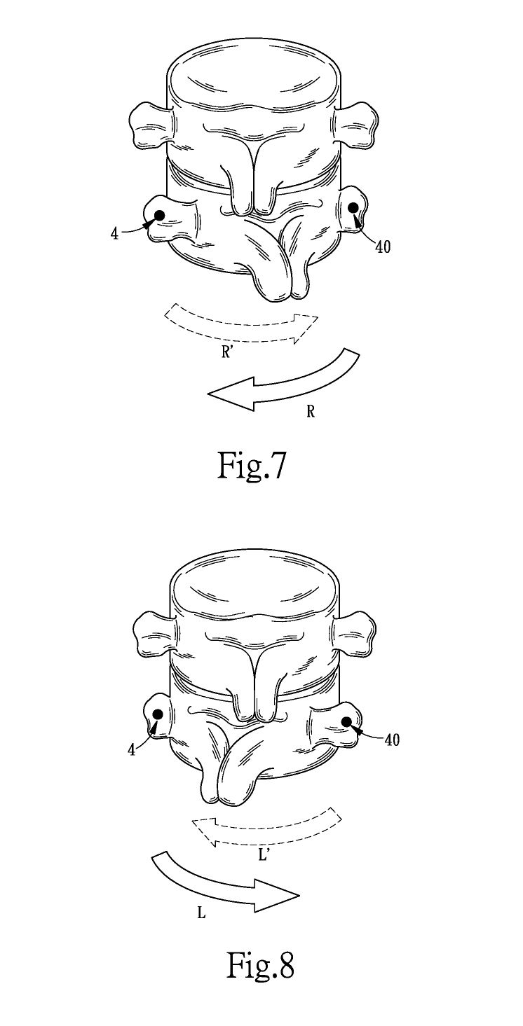

FIG. 7 provides an illustrative view of the right-rotation symptom of the spine joint according to an embodiment of the present invention. Additional attention is also directed to FIG. 1. As illustrated in the direction of R′ in FIG. 7, the adjustment knobs 341 and 342 may respectively activate the adjustment units 331 and 332. In some circumstance, the main circuit board 31 may configure the impact power unit 2 to have the regular linear-motion impact with “medium-strong” force and 12 times per second frequency. It may additionally use the adjustment knobs 343 and 344 to activate the adjustment units 333 and 334 to use the main circuit board 31 to control the regular linear-motion impact of the impact power unit 20 with “weak” force and 2 times per second frequency. Then, a user may place the impact head 4 of the impact power unit 2 against the left side of the fourth section of the spine joint, and may place the impact head 40 of the impact power unit 20 against the right side of the fourth section of the lumbar joint. By pressing the operational switch 32, the two impact power units 2 and 20 will be activated, and, in a few seconds, the right-rotation symptom may be alleviated to left-restore them to the normal position. This is due to the two impact power units 2 and 20 being able to provide regular linear-motion impacts with different forces and frequencies, thereby producing a left-restoring loosing force in the direction as depicted in the solid arrow R in FIG. 7. A protection effect can also be produced because the impact power unit 20 applies a smaller force than the impact power unit 2, and a loosing effect can be produced because the impact power unit 20 has a smaller frequency than the impact power unit 2.

FIG. 8 provides an illustrative view of the left-rotation symptom of the spine joint according to an embodiment of the present invention. Additional attention is also directed to FIG. 1. As illustrated in the direction of L′ in FIG. 8, the adjustment knobs 341 and 342 may respectively activate the adjustment units 331 and 332. In some circumstance, the main circuit board 31 may configure the impact power unit 2 to have the regular linear-motion impact with “weak” force and 2 times per second frequency. It may additionally use the adjustment knobs 343 and 344 to activate the adjustment units 333 and 334 to use the main circuit board 31 to control the regular linear-motion impact of the impact power unit 20 with “medium-strong” force and 12 times per second frequency. Then, a user may place the impact head 4 of the impact power unit 2 against the left side of the fourth section of the spine joint, and place the impact head 40 of the impact power unit 20 against the right side of the fourth section of the spine joint. By pressing the operational switch 32, the two impact power units 2 and 20 will be activated, and, in a few seconds, as depicted in the solid arrow L in FIG. 8, the left-rotation symptom may be alleviated by right-restoring them to the normal position.

Accordingly, the massager in accordance with the present invention can apply regular linear-motion impacts with different forces and frequencies to quickly provide a relaxing effect. and easy to activate these tissue. Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. An improved massager, comprising:
a chassis with a housing space wherein the chassis reaches out through two openings at a side of the chassis;
two impact power units configured inside the housing space and partially passing through the two openings to respectively connect to two massage heads; and
a control unit comprising a main circuit board, an operational switch with at least one mode of operation, a control circuit board, and a plurality of adjustment knobs configured outside of the chassis to be linked with a plurality of adjustment units on the control circuit board, wherein the main circuit board is connected to the control circuit board and the two impact power units to drive the plurality of adjustment units through the operational switch to provide different configurations for the two impact power units so that the two massage heads can provide regular linear-motion impacts with different forces and frequencies.

2. The improved massager of claim 1, wherein the chassis laterally extends a grip portion that has the operational switch to control the two impact power units.

3. The improved massager of claim 1, wherein the chassis comprises two corresponding side cases and a back cover that combines with the two corresponding side cases.

4. The improved massager of claim 1, wherein the two impact power units are similarly structured to comprise an electromagnetic element, a driving unit group, a transmission unit, and a fixture, wherein the electromagnetic element comprise a wounded coil with a through hole, wherein the driving unit group comprises a driving pillar capable of reaching through the through hole and connects to a link that also connects to a fit member, wherein the transmission unit partially extends outside of a lower sleeve of the chassis, and wherein the lower sleeve comprises a center hole associated with the fit member and a driving pillar that at one end reaches inside the center hole to be placed against the fit member and at another end reaches the fixture.

5. The improved massager of claim 4, wherein the electromagnetic element is placed inside an upper sleeve that combines with an end plug with a hole for the link to pass through, wherein the link is surrounded by a spring to be placed against the driving pillar and the end plug, and wherein the lower sleeve is surrounded by a linking cylinder to be coupled to an end of the end plug that is away from the upper sleeve.

6. The improved massager of claim 5, wherein the linking cylinder is placed inside and against the opening of the chassis, and wherein the lower sleeve extends outward through the opening.

7. The improved massager of claim 4, wherein a middle section of the lower sleeve has a ring flange to stop an outer flange of the driving pillar to prevent the driving pillar from sliding outward.

8. The improved massager of claim 2, wherein the grip portion of the chassis is hollow and contains the main circuit board.
